(19) United States
(12) Patent Application Publication
(10) Pub. No.: US 2014/0094561 A1
(43) Pub. Date: Apr. 3, 2014

(54) PROCESS FOR PRODUCING COMPOSITE MATERIALS

(71) Applicant: BASF SE, Ludwigshafen (DE)

(72) Inventors: Arno Lange, Bad Durkheim (DE); Theo Smit, Heidelberg (DE); Raineer Dyllick-Brenzinger, Ludwigshafen (DE); Oliver Gronwald, Frankfurt (DE); Gerhard Cox, Bad Durkheim (DE); Stefan Spange, Orlamunde (DE); Patrick Kempe, Chemnitz (DE); Tina Mark, Neustadt (DE)

(73) Assignee: BASF SE, Ludwigshafen (DE)

(21) Appl. No.: 14/038,947

(22) Filed: Sep. 27, 2013

Related U.S. Application Data
(60) Provisional application No. 61/706,797, filed on Sep. 28, 2012.

(51) Int. Cl. C08L 83/04

(52) U.S. Cl. CPC C08L 83/04
USPC 524/588

(57) ABSTRACT

The present invention relates to a process for producing a composite material composed of at least one inorganic or organometallic phase and one organic polymer phase with aromatic or heteroaromatic structural units, wherein homo- or copolymerization of the monomers of the formula I is performed in the presence of a base selected from organic nitrogen bases and inorganic or organic oxo bases and fluoride salts.

### CROSS-REFERENCE TO RELATED APPLICATIONS

This application claims benefit (under 35 USC 119(e)) of U.S. Provisional Application Ser. No. 61/706,797, filed Sep. 28, 2012, which is incorporated herein by reference in its entirety.

### BACKGROUND OF THE INVENTION

The present invention relates to a process for producing composite materials formed from
a) at least one inorganic or organometallic phase; and
b) at least one organic polymer phase with aromatic or heteroaromatic structural units.

Composite materials, i.e. polymer-based composites formed from at least one organic polymer phase and at least one inorganic or organometallic phase, for example an inorganic metal oxide phase, often feature interesting physical properties, for example mechanical, electrical and/or optical properties.

In recent times, there have been various reports on nanocomposite materials. These are understood to mean composite materials in which the domains of the various phases have dimensions below 500 nm, especially below 100 nm (hereinafter also nanoscale phase or, in the case of a particulate phase, nanoscale particles). Due to the large interface between the nanoscale inorganic or organometallic phase and the organic polymer phase, such materials have a high potential in terms of their chemical, physical and mechanical properties, which cannot be achieved by milli- or microscale dispersions of conventional inorganic constituents in polymer phases (R. P. Singh et al., J. Mater. Sci. 2002, 37, 781).

The processes known to date for producing inorganic-organic nanocomposites are based on direct mixing of nanoparticles or exfoliated sheet silicates with a polymer in solution or in the melt, the in situ production of the organic phase by polymerizing organic monomers in the presence of inorganic nanoparticles or exfoliated sheet silicates, sol-gel techniques and combinations of these measures (see, for example, for incorporation of nanoparticles into a polymer melt: M. Garcia et al., Polymers for Advanced Technologies 2004, 15, 164; for polymerization of organic monomers in the presence of inorganic nanoparticles or exfoliated sheet silicates see: M. C. Kuo et al., Materials Chemistry and Physics 2005, 90(1), 185; A. Malty et al., Journal of Applied Polymer Science 2004, 94(2), 803; Y. Liao et al (Polymer International 2001, 50(2), 207; and WO 2001/012678; for production of an oxide phase by hydrolysis of oligomeric alkoxysiloxanes in a polymer solution or melt see WO 2004/058859 and WO 2007/028563).

The established prior art methods are associated with a number of disadvantages. Firstly, many of them remain restricted to composites of organic polymers which are either soluble in organic solvents or melt without decomposition. In addition, it is generally possible in this way only to introduce small amounts of inorganic phase into the nanocomposite material. Owing to the usually high agglomeration of the nanoparticles and the enormously high shear forces which are necessary as a result, fine distribution of the nanoparticles in any large amount is barely possible. A great disadvantage of nanocomposite production by in situ production of the organic polymer phase in the presence of nanoparticles is the occurrence of formation of nanoparticle agglomerates, such that inhomogeneous products form. This makes it impossible to utilize the advantage of the nanoparticles that of forming extensive interfaces with the polymer as a result of their large surface area. In the case of use of pulverulent nanofillers, owing to the small particle size, there is additionally a high risk to health during compounding owing to the dust formation which occurs and the ability of the nanoparticles to reach the lungs. The in situ production of the inorganic phase by a sol-gel process in a polymer melt or solution generally leads to poorly reproducible results or requires complex measures to control the hydrolysis conditions.

Spange et al., Angew. Chem. Int. Ed. 2007, 46, 628-632 describe a novel route to nanocomposite materials by acid-catalyzed cationic polymerization of tetrafurfuryloxysilane TFOS and difurfuryloxydimethylsilane. The polymerization of TFOS under cationic, i.e. acidic conditions forms a composite material which has a silicon dioxide phase and an organic polymer phase composed of polyfurfuryl alcohol PFA. The dimensions of the phase domains in the composite material thus obtained are in the region of a few nanometers. In addition, the phase domains of the silicon dioxide phase and the phase domains of the PFA phase have a co-continuous arrangement, i.e. both the PFA phase and the silicon dioxide phase penetrate one another and essentially do not form any discontinuous regions. The distances between adjacent phase interfaces, or the distances between the domains of adjacent identical phases, are extremely small and are on average not more than 10 nm. Macroscopically visible separation into discontinuous domains of the respective phase occurs only to a minor extent, if at all, in the process described by Spange et al. It is assumed that the specific phase arrangement achieved by the process of Spange et al. and the small distances between adjacent phases are a consequence firstly of the kinetic coupling of the polymerization of the furfuryl units, and secondly of the formation of the silicon dioxide. Consequently, the phase constituents probably form more or less synchronously, and it is assumed that there is a phase separation into the inorganic phase and the organic phase as early as during the polymerization of TFOS. For this reason, the term “twin polymerization” has become established for this polymerization type.

Similar processes for producing nanocomposite materials by twin polymerization are known from WO 2009/083083, WO 2009/133086, WO 2010/128144, WO 2010/112581 and WO 2011/000858. These processes relate to the homo- or copolymerization of at least one monomer from the monomers of the general formula I defined hereinafter, in the presence of acidic catalysts at temperatures of preferably below 120° C.

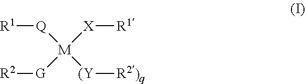

In formula I, the variables M, R¹, R², R^{1′}, R^{2′}, q, Q, G, X and Y are each defined as follows:
M is a metal or semimetal, generally a metal or semimetal of main group 3 or 4 or of transition group 4 or 5 of the periodic table, for example B, Al, Si, Ti, Zr, Hf, Ge, Sn, Pb, V, As, Sb or Bi, or B, Si, Ti, Zr or Sn, especially Si or Sn and very especially Si;
R¹, R² are the same or different and are each an Ar—C(R^{a},R^{b})— radical in which Ar is an aromatic or heteroaromatic ring and especially a phenyl ring, where Ar is unsubstituted or optionally has 1 or 2 substituents selected from halogen, CN, C₁-C₆-alkyl, C₁-C₆-alkoxy and phenyl, and R^{a}, R^{b} are each independently hydrogen or methyl or together are an oxygen atom or a methylidene group (═CH₂),
   or the R¹Q and R²G radicals together are a radical of the formula A

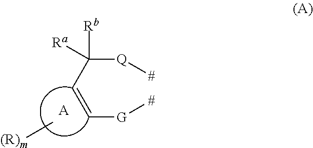

in which A is an aromatic or heteroaromatic ring and especially a benzene ring fused to the double bond, m is 0, 1 or 2, the R radicals may be the same or different and are selected from halogen, CN, C₁-C₆-alkoxy and phenyl, and R^{a}, R^{b} are each as defined above;
G is O, S or NH;
Q is O, S or NH;
q according to the valency and charge of M is 0, 1 or 2;
X, Y are the same or different and are each O, S, NH or a chemical bond;
R^{1′}, R^{2′} are the same or different and are each C₁-C₆-alkyl, C₃-C₆-cycloalkyl, aryl or an Ar′-C(R^{a′},R^{b′})— radical in which Ar′ is as defined for Ar and R^{a′}, R^{b′} are each as defined for R^{a}, R^{b}, or R^{1′}, R^{2′} together with X and Y are a radical of the formula A, as defined above,
or, when X is oxygen, the R^{1′} radical may also be a radical of the following formula:

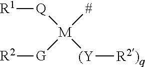

in which q, R¹, R², R^{2′}, Y, Q and G are each as defined above and # is the bond to X.

The prior art twin polymerization processes involving monomers of the formula I afford nanoscale composite materials formed from
a) at least one inorganic or organometallic phase; and
b) at least one organic polymer phase with aromatic or heteroaromatic structural units.

The dimensions of the phase domains in the composite materials thus obtained are generally less than 200 nm and are frequently in the region of a few nanometers, for example not more than 50 nm or not more than 20 nm or not more than 10 nm or not more than 5 nm. In addition, the phase domains of the inorganic or organometallic phase and the phase domains of the organic phase typically have a co-continuous arrangement, i.e. both the organic phase and the inorganic or organometallic phase penetrate one another and essentially do not form any discontinuous regions. The distances between adjacent phase boundaries, or the distances between the domains of adjacent identical phases, are extremely small and are generally on average not more than 200 nm, frequently on average not more than 50 nm or 20 nm and especially on average not more than 10 nm, or not more than 5 nm. There is typically no occurrence of macroscopically visible separation into discontinuous domains of the particular phase in such processes.

Disadvantages of the prior art processes are particularly the uncontrolled, rapid reaction, an associated short processing time window, and the occurrence of problems in the case of acid-labile surfaces. The prior art processes for homo- or copolymerization have been found to be particularly disadvantageous when, for example, the monomers of the formula I are homo- or copolymerized in a thin layer. It is possible in this way to produce thin polymer layers. However, the layers thus produced are often found to be defective or have other disadvantages, for example low mechanical stability, unwanted discoloration, inhomogeneous layer thickness, inhomogeneity within the layer or only moderate adhesion on the coated substrate. Moreover, the acid used for catalysis of the polymerization can attack the substrate to be coated and thus lead to further problems.

It has now been found that the aforementioned monomers of the formula I can particularly advantageously be homo- or copolymerized in the presence of particular bases, namely bases from the group of the organic nitrogen bases and inorganic or organic oxo bases and fluoride salts. In this way, it is possible to overcome the disadvantages of the prior art. Due to the base-catalyzed initiation, it is possible to avoid the problems which occur in the case of the acid catalysis employed in the prior art.

### BRIEF SUMMARY OF THE INVENTION

Accordingly, the present invention relates to a process for producing composite materials, more particularly to a process for producing nanocomposite materials formed from
a) at least one inorganic or organometallic phase; and
b) at least one organic polymer phase with aromatic or heteroaromatic structural units,
   comprising the homo- or copolymerization of at least one monomer of the formula I as defined above, which comprises performing the polymerization of the monomers of the general formula I in the presence of a base selected from organic nitrogen bases and inorganic or organic oxo bases and fluoride salts.

### BRIEF DESCRIPTION OF THE SEVERAL VIEWS OF THE DRAWING

FIG. 1 shows DSC analyses of monomer A with 1,8-bis(dimethylamino)naphthalene (BDMAN) as a base in various molar ratios of monomer A to 1,8-bis(dimethylamino)-naphthalene (BDMAN) at a heating rate of 10 K/min under a nitrogen atmosphere.

FIG. 2 shows an HAADF-STEM image of polymerization example 1 (scale 20 000:1).

FIG. 3 shows an HAADF-STEM image of polymerization example 1 (scale 200 000:1).

FIG. 4 shows an HAADF-STEM image of polymerization example 2 (scale 200 000:1).

### DETAILED DESCRIPTION OF THE INVENTION

In the inventive composite materials, the inorganic or organometallic phase comprises the metal or semimetal M and optionally, when X or Y is a chemical bond, the organic R^{1′} and R^{2′} radicals. The at least one organic polymer phase in turn comprises polymers with aromatic or heteroaromatic structural units which from the polymerization of the R¹ and R² radicals and optionally, when X and Y are not a chemical bond, of the R^{1′} and R^{2′} radicals.

Surprisingly, the inventive base catalysis leads to results comparable to those under acid catalysis. For instance, the dimensions of the phase domains in the composite materials obtained in accordance with the invention are generally less than 200 nm and are frequently in the region of a few nanometers, for example not more than 50 nm or not more than 20 nm or not more than 10 nm or not more than 5 nm.

The advantages of the process according to the invention are evident especially when the monomers of the formula I are homo- or copolymerized in a thin layer. In this way, it is possible to produce thin layers of the composite material which do not have at least some of the disadvantages of the prior art and are especially set apart from the prior art by at least one of the following advantages:
fewer defects within the layer,
improved mechanical stability of the layer,
lower discoloration, if any,
more homogeneous layer thickness,
less inhomogeneity, if any, within the layer,
better adhesion on the coated substrate.

A further advantage is that the base-catalyzed homo- or copolymerization of the monomers of the formula I generally proceeds in a slower and more controlled manner than the acid-catalyzed homo- or copolymerization. This leads to a longer time window within which the reaction mixture of monomers of the formula I and the inventive bases can be processed. It is thus possible, for example, to process the reaction mixture at room temperature at first, for example apply it to a substrate, in order to produce a coating, and then to heat the reaction mixture to start the polymerization reaction.

In addition, for performance of the polymerization, the catalytic use of acid can be dispensed with, and so it is also possible to coat those substrates which are attacked by the acid used for catalysis in the prior art processes.

Accordingly, a preferred configuration of the process according to the invention relates to the production of a coating, which comprises the following steps:
i) applying a layer of at least one monomer of the formula I as defined in claim 1 to a surface to be coated in presence of a basic catalyst and
ii) triggering a homo- or copolymerization of the at least one monomer of the formula I in the layer by heating the layer.

In this way, a coating in the form of a composite material with the above-mentioned properties is obtained on the coated substrate.

As already explained above, the process according to the invention is performed in the presence of a basic catalyst. In general, the amount of added base will be in the range from 0.01 mmol to 2 mmol, based on 4 mmol of the monomers of the formula I.

Bases used in accordance with the invention are selected from organic nitrogen bases, inorganic or organic oxo bases and fluoride salts.

The catalysts used are preferably those bases whose conjugate acids have a pKₐ of 4.0 or more, measured in water at 25° C., for example a pKₐ in the range from 4 to 14.

Inorganic or organic oxo bases are understood to mean inorganic or organic bases whose conjugate acid has one or more acidic protons bonded directly to one or more oxygen atoms. Examples are alkali metal C₁-C₁₀-alkoxides, alkaline earth metal C₁-C₁₀-alkoxides, alkali metal hydroxides, alkaline earth metal hydroxides, alkali metal carbonates, alkaline earth metal carbonates and the like.

In the context of the invention, secondary organic amines are understood to mean amines having at least one nitrogen atom bearing 1 hydrogen atom. These include particularly amines of the formula R³R⁴NH where R³ and R⁴ are each independently substituted or unsubstituted C₁-C₁₀-alkyl, C₃-C₁₀-cycloalkyl, C₃-C₁₀-heterocycloalkyl, where C₃-C₁₀-heterocycloalkyl comprises at least one heteroatom selected from N, O and S, C₅-C₁₄-aryl or C₅-C₁₀-heteroaryl, where C₅-C₁₀-heteroaryl comprises at least one heteroatom selected from N, O and S, or in which R³ and R⁴ together with the NH group to which they are bonded are a 5- to 10-membered heterocycle which, as well as the NH group, may have 1 or 2 further heteroatoms or heteroatom groups selected from O, S, SO, SO₂ and NH. Examples of secondary organic amines are piperidine, pyrrolidine, morpholine, thiomorpholine, dimethylamine, diethylamine, di-n-propylamine, dicyclohexylamine, diphenylamine, N-methyl-N-cyclohexylamine and the like.

In the context of the invention, tertiary organic amines are understood to mean amines having at least one nitrogen atom not having any hydrogen atoms bonded to the nitrogen atom. These include, for example, amines of the formula R⁵R⁶R⁷N, where R⁵, R⁶ and R⁷ are each independently substituted or unsubstituted C₁-C₁₀-alkyl, C₃-C₁₀-cycloalkyl, C₃-C₁₀-heterocycloalkyl, where C₃-C₁₀-heterocycloalkyl comprises at least one heteroatom selected from N, O and S, C₅-C₁₄-aryl or C₅-C₁₀-heteroaryl, where C₅-C₁₀-heteroaryl comprises at least one heteroatom selected from N, O and S. These also include amines of the formula R⁸═N—R⁹, in which R⁸ and R⁹, together with the nitrogen atom to which they are bonded, are a 5- to 10-membered aromatic or nonaromatic heterocycle which, as well as the nitrogen atom, may have 1 or 2 further heteroatoms or heteroatom groups selected from O, S, SO, SO₂ and N. Examples of tertiary organic amines are pyridine, 1,1,3,3-tetramethylguanidine, 4-(dimethylamino)-pyridine, 1,8-diazabicyclo[5.4.0]undec-7-ene (DBU), 1,5-diazabicyclo[4.3.0]non-5-ene (DBN), 1,8-bis(di-C₁-C₄-alkylamino)naphthalenes and 1,4-diazabicyclo[2.2.2]octane (DABCO®).

Specific tertiary organic amines which can be used in the context of the invention are 1,8-bis(di-C₁-C₄-alkylamino)naphthalenes. These are naphthalenes each bearing an amino group in the 1 and 8 positions, where the 4 hydrogen atoms of the two amino groups are each independently replaced by a C₁-C₄-alkyl radical. Examples are 1,8-bis(dimethylamino)naphthalene (BDMAN, “proton sponge”) and 1,8-bis(diethylamino)-naphthalene.

Further specific tertiary amines which can be used in the context of the invention are tertiary amidine bases. Tertiary amidine bases have the general structural formula R¹⁰—C(═NR¹¹)—NR¹²R¹³, where R¹⁹ is a carbonaceous radical, e.g. alkyl or aryl, and R¹¹, R¹² and R¹³ are each independently an alkyl radical, or R¹⁹ and R¹¹, together with the nitrogen atom to which they are bonded, are a 5- to 10-membered heterocycle which, as well as the nitrogen atom, may have 1 or 2 further heteroatoms or heteroatom groups selected from O, S, SO, SO₂, N and NH, and/or R¹² and R¹³, together with the nitrogen atom to which they are bonded, are a 5- to 10-membered heterocycle which, as well as the nitrogen atom, may have 1 or 2 further heteroatoms or heteroatom groups selected from O, S, SO, SO₂, N and NH. Examples of tertiary amidine bases are 1,8-diazabicyclo[5.4.0]undec-7-ene (DBU), 1,5-diazabicyclo[4.3.0]non-5-ene (DBN), N,N-dimethyl-N′-phenylformamidine and N,N,N′-trimethylformamidine.

Alkali metal hydroxides which can be used as bases in the process according to the invention are, for example, the hydroxides of lithium, sodium, potassium, rubidium or cesium, preferably sodium hydroxide and potassium hydroxide, more preferably sodium hydroxide. Alkaline earth metal hydroxides which can be used as bases in the process according to the invention are, for example, the hydroxides of magnesium, calcium or barium, preferably magnesium hydroxide and calcium hydroxide.

C₁-C₁₀-alkoxides which can be used as bases in the context of the invention are understood to mean especially the alkali metal salts and alkaline earth metal salts of aliphatic, cycloaliphatic and aromatic alcohols having 1 to 10 carbon atoms, for example lithium methoxide, lithium ethoxide, lithium n-propoxide, lithium isopropoxide, lithium n-butoxide, lithium isobutoxide, lithium n-pentoxide, lithium n-hexoxide, lithium n-heptoxide, lithium n-octoxide, lithium benzoxide, lithium phenoxide, potassium methoxide, potassium ethoxide, potassium n-propoxide, potassium isopropoxide, potassium n-butoxide, potassium isobutoxide, potassium n-pentoxide, potassium n-hexoxide, potassium n-heptoxide, potassium n-octoxide, potassium benzoxide, potassium phenoxide, sodium methoxide, sodium ethoxide, sodium n-propoxide, sodium isopropoxide, sodium n-butoxide, sodium isobutoxide, sodium n-pentoxide, sodium n-hexoxide, sodium n-heptoxide, sodium n-octoxide, sodium benzoxide, sodium phenoxide, and the constitutional isomers of the alkali metal alkoxides mentioned.

Quaternary ammonium fluorides which can be used as bases in the context of the invention are understood to mean salts having a fluoride ion as the anion and an ion of the formula R¹⁴R¹⁵R¹⁶R¹⁷N⁺ as the cation. The R¹⁴, R¹⁵, R¹⁶ and R¹⁷ radicals here are each independently C₁-C₂₀-alkyl, C₃-C₇-cycloalkyl, C₆-C₁₀-aryl, especially linear C₁-C₂₀-alkyl. Examples of quaternary ammonium fluorides are tetra-n-butylammonium fluoride, tetramethylammonium fluoride, tetra-n-propylammonium fluoride, tetra-n-hexyl-ammonium fluoride and tetra-n-heptylammonium fluoride.

Here and hereinafter, an aromatic radical or aryl is understood to mean a carbocyclic aromatic hydrocarbyl radical such as phenyl or naphthyl.

In the context of the invention, a heteroaromatic radical or hetaryl is understood to mean a heterocyclic aromatic radical which generally has 5 or 6 ring members, where one of the ring members is a heteroatom selected from nitrogen, oxygen and sulfur, and 1 or 2 further ring members may optionally be a nitrogen atom and the remaining ring members are carbon. Examples of heteroaromatic radicals are furyl, thienyl, pyrrolyl, pyrazolyl, imidazolyl, oxazolyl, isoxazolyl, pyridyl or thiazolyl.

In the context of the invention, a fused aromatic radical or ring is understood to mean a carbocyclic aromatic divalent hydrocarbon radical such as o-phenylene (benzo) or 1,2-naphthylene (naphtho).

In the context of the invention, a fused heteroaromatic radical or ring is understood to mean a heterocyclic aromatic radical as defined above, in which two adjacent carbon atoms form the double bond shown formula A or in the formulae II and III.

“C₁-C₁₀-alkyl” is a linear or branched alkyl radical having 1 to 10 carbon atoms. Examples of C₁-C₁₀-alkyl are methyl, ethyl, n-propyl, isopropyl, n-butyl, 2-butyl, isobutyl, tert-butyl (2-methylpropan-2-yl), n-pentyl (amyl), 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, heptyl, octyl, 2-ethylhexyl, nonyl, decyl and the constitutional isomers thereof.

“C₃-C₁₀-cycloalkyl” is a mono-, di-, tri- or tetracyclic alkyl radical having 3 to 10 carbon atoms. Examples are cyclopropyl, cyclobutyl, cyclopentyl, cyclohexyl, cycloheptyl, cyclooctyl and adamantyl.

The base used in the process according to the invention is preferably selected from secondary and tertiary organic amines, alkali metal hydroxides, alkaline earth metal hydroxides, C₁-C₁₀-alkoxides and quaternary ammonium fluorides.

The base is more preferably selected from 1,8-bis(di-C₁-C₄-alkylamino)naphthalenes, pyrrolidine, 1,1,3,3-tetramethylguanidine, tertiary amidine bases, 4-(dimethylamino)-pyridine, pyridine, piperidine, tetra-n-butylammonium fluoride, sodium hydroxide and C₁-C₁₀-alkoxides, especially alkali metal C₁-C₁₀-alkoxides and alkaline earth metal C₁-C₁₀-alkoxides, for example sodium methoxide, sodium ethoxide, potassium methoxide and potassium ethoxide.

The base is most preferably selected from tertiary amidine bases and 1,8-bis(di-C₁-C₄-alkylamino)naphthalenes.

The base is especially selected from 1,8-bis(dimethylamino)naphthalene, 1,8-diazabicyclo[5.4.0]undec-7-ene and 1,5-diazabicyclo[4.3.0]non-5-ene.

It is also possible to use mixtures of different bases.

Preferred monomers of the formula I for the process according to the invention are those in which M in formula I is selected from the metals and semimetals of main group 3 (IUPAC group 3), especially B or Al, metals and semimetals of main group 4 of the periodic table (IUPAC group 14), especially Si, Ge, Sn or Pb, semimetals of main group 5 of the periodic table (IUPAC group 15), especially As, Sb and Bi, metals of transition group 4 of the periodic table, especially Ti, Zr and Hf, and metals of transition group 5 of the periodic table, such as V. The process according to the invention is especially suitable for polymerization of those monomers of the formula I in which M is selected from the metals and semimetals of main group 4 of the periodic table, especially Si, Ge, Sn or Pb, and metals of transition group 4 of the periodic table, especially Ti, Zr and Hf. The process according to the invention is suitable with particular preference for polymerization of those monomers of the formula I in which M at least in a portion of or the entirety of the monomers is essentially or exclusively silicon. In a likewise very particularly preferred embodiment, M in formula I is boron. In a likewise particularly preferred embodiment, M in formula I is tin.

Preferred monomers of the formula I for the process according to the invention are those in which G and Q in formula I are each oxygen.

Preferred monomers of the formula I for the process according to the invention are those in which X and Y, if present, are each oxygen.

Preferred monomers of the formula I for the process according to the invention are those in which q is 1 and M is selected from Si, Sn and Ti and is especially Si.

Preferred monomers of the formula I for the process according to the invention are also those in which q is 0 and M is B.

In a first embodiment of the monomers of the formula I, the R¹Q and R²G groups together are a radical of the formula A as defined above, especially a radical of the formula Aa:

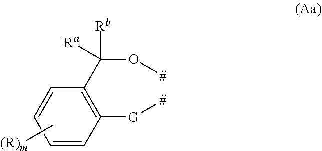

in which #, m, R, R^{a} and R^{b} are each as defined above. In the formulae A and Aa, the variable m is especially 0. When m is 1 or 2, R is especially a methyl or methoxy group. In the formulae A and Aa, R^{a} and Rb are especially each hydrogen. In formula A, Q is especially oxygen. In the formulae A and Aa, G is especially oxygen or NH, especially oxygen.

Among the monomers of the formula I, preference is given especially to those compounds in which q=1 and in which the X—R^{1′} and Y—R^{2′} groups together are a radical of the formula A, especially a radical of the formula Aa. Such monomers can be described by the following formulae I-A and I-Aa:

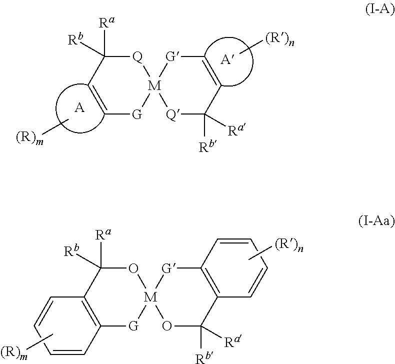

Among the monomers of the formula I, preference is further given to those compounds in which q is 0 or 1 and in which the X—R^{1′} group is a radical of the formula A′ or Aa′:

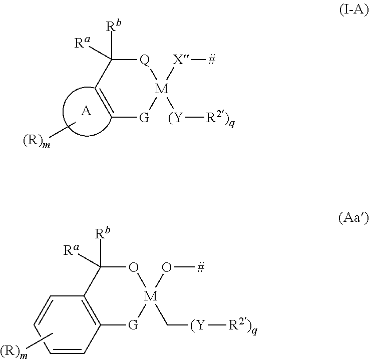

in which m, A, R, R^{a}, R^{b}, G, Q, X″, Y, R^{2′} and q have the aforementioned definitions, especially those specified as preferred.

Such monomers can be described by the following formulae I-A′ and I-Aa′:

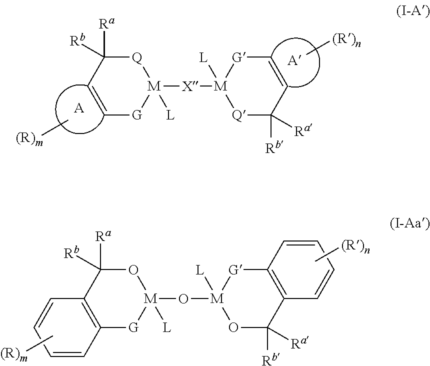

In the formulae I-A and I-A′, the variables are preferably each defined as follows:
M is a metal or semimetal, preferably a metal or semimetal of main group 3 or 4 or of transition group 4 or 5 of the periodic table, especially B, Al, Si, Ti, Zr, Hf, Ge, Sn, Pb, V, As, Sb or Bi, more preferably B, Si or Sn, especially Si;
A, A′ are each independently an aromatic or heteroaromatic ring fused to the double bond;
m, n are each independently 0, 1 or 2, especially 0;
G, G′ are each independently O, S or NH, particularly O or NH and especially 0;
Q, Q′ are each independently O, S or NH, especially O;
R, R′ are each independently selected from halogen, CN, C₁-C₆-alkyl, C₁-C₆-alkoxy and phenyl, and are especially each methyl or methoxy;
R^{a}, R^{b}, R^{a′}, R^{b′} are each independently selected from hydrogen and methyl, or R^{a} and R^{b} and/or R^{a′} and R^{b′} in each case together are an oxygen atom or ═CH₂; in particular, R^{a}, R^{b}, R^{a′}, R^{b′} are each hydrogen,
L is a (Y—R^{2′})_{q} group in which Y, R^{2′} and q are each as defined above and
X″ has one of the definitions given for Q and is especially oxygen.

In the formulae I-Aa and I-Aa′, the variables are preferably each defined as follows:
M is a metal or semimetal, preferably a metal or semimetal of main group 3 or 4 or of transition group 4 or 5 of the periodic table, especially B, Al, Si, Ti, Zr, Hf, Ge, Sn, Pb, V, As, Sb or Bi, more preferably B, Si or Sn, especially Si;
m, n are each independently 0, 1 or 2, especially 0;
G, G′ are each independently O, S or NH, particularly O or NH and especially 0;
R, R′ are each independently selected from halogen, CN, C₁-C₆-alkyl, C₁-C₆-alkoxy and phenyl, and are especially each methyl or methoxy;
R^{a}, R^{b}, R^{a′}, R^{b′} are each independently selected from hydrogen and methyl, or R^{a} and R^{b} and/or R^{a′} and R^{b′} in each case together are an oxygen atom or ═CH₂; in particular, R^{a}, R^{b}, R^{a′}, R^{b′} are each hydrogen,
L is a (Y—R^{2′})_{q} group in which Y, R^{2′} and q are each as defined above.

In the formulae I-A and I-A′, the variables are especially each defined as follows:
M is silicon;
A and A′ are each a benzene ring fused to the double bond;
m and n are each independently 0 or 1;
G and Q are each 0;
R and R′ are the same or different and are each independently selected from halogen, CN, C₁-C₆-alkyl and C₁-C₆-alkoxy; and
R^{a}, R^{b}, R^{a′}, R^{b′} are each hydrogen.

In the formulae I-Aa and I-Aa′, the variables are especially each defined as follows:
M is silicon;
m and n are each independently 0 or 1;
G, G′, Q and Q′ are each O;
R and R′ are the same or different and are each independently selected from halogen, CN, C₁-C₆-alkyl and C₁-C₆-alkoxy; and
R^{a}, R^{b}, R^{a′}, R^{b′} are each hydrogen.

One example of a monomer of the formula I-A or I-Aa is 2,2′-spirobis[4H-1,3,2-benzodioxasilin] (compound of the formula I-Aa where M=Si, m=n=0, G=O, R^{a}═R^{b}═R^{a′}═R^{b′}=hydrogen). Such monomers are known from WO 2009/083082 and WO 2009/083083 or can be prepared by the methods described therein. A further example of a monomer I-Aa is 2,2-spirobis[4H-1,3,2-benzodioxaborin] (Bull. Chem. Soc. Jap. 1978, 51, 524: (compound of the formula IIa where M=B, m=n=0, G=O, R^{a}═R^{b}═R^{a′}═R^{b′}=hydrogen). A further example of a monomer I-Aa′ is bis(4H-1,3,2-benzodioxaborin-2-yl) oxide (compound of the formula I-Aa′ where M=B, m=n=0, L absent (q=0), G=O, R^{a}═R^{b}═R^{a′}═R^{b′}=hydrogen; Bull. Chem. Soc. Jap. 1978, 51, 524).

In a preferred embodiment, the monomers of the formula Ito be polymerized comprise exclusively the monomers of the formula I-A or I-A′ specified as preferred, especially those of the formula I-Aa or I-Aa′.

In a further preferred embodiment, the monomers of the formula Ito be polymerized comprise at least one first monomer M1 of the formula I-A, especially at least one monomer of the formula I-Aa and at least one second monomer M2 selected from the monomers of the formula I-B, especially of the formula I-Ba:

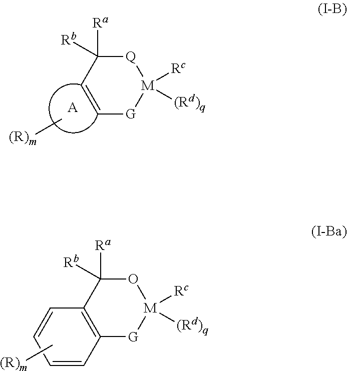

In formula I-B, the variables are preferably each defined as follows:
M is a metal or semimetal, preferably a metal or semimetal of main group 3 or 4 or of transition group 4 or 5 of the periodic table, especially B, Al, Si, Ti, Zr, Hf, Ge, Sn, Pb, V, As, Sb or Bi, more preferably B, Si, Ti, Zr or Sn, especially Si;
A is an aromatic or heteroaromatic ring fused to the double bond and is especially O;
m is 0, 1 or 2, especially 0;
q according to the valency and charge of M is 0, 1 or 2;
G is O, S or NH, particularly O or NH and especially 0;
Q is O, S or NH, especially 0;
R are independently selected from halogen, CN, C₁-C₆-alkyl, C₁-C₆-alkoxy and phenyl, and are especially methyl or methoxy;
R^{a}, R^{b} are each independently selected from hydrogen and methyl, or R^{a} and R^{b} together are an oxygen atom or ═CH₂; R^{a} and Rb are especially both hydrogen;
R^{a}, R^{d} are the same or different and are selected from C₁-C₆-alkyl, C₃-C₆-cycloalkyl and aryl, and are especially each methyl.

In formula I-Ba, the variables are preferably each defined as follows:
M is a metal or semimetal, preferably a metal or semimetal of main group 3 or 4 or of transition group 4 or 5 of the periodic table, especially B, Al, Si, Ti, Zr, Hf, Ge, Sn, Pb, V, As, Sb or Bi, more preferably B, Si, Ti, Zr or Sn, especially Si;
m is 0, 1 or 2, especially 0;
G is O, S or NH, particularly O or NH and especially 0;
R are independently selected from halogen, CN, C₁-C₆-alkyl, C₁-C₆-alkoxy and phenyl, and are especially methyl or methoxy;
R^{a}, R^{b} are each independently selected from hydrogen and methyl, or R^{a} and R^{b} together are an oxygen atom or ═CH₂; R^{a} and R^{b} are especially both hydrogen;
R^{c}, R^{d} are the same or different and are each selected from C₁-C₆-alkyl, C₃-C₆-cycloalkyl and aryl, and are especially each methyl.

Examples of monomers of the formula I-B or I-Ba are 2,2-dimethyl-4H-1,3,2-benzodioxasilin (compound of the formula I-Ba where M=Si, q=1, m=0, G=O, R^{a}═R^{b}=hydrogen, R^{c}═R^{d}=methyl), 2,2-dimethyl-4H-1,3,2-benzoxazasilin (compound of the formula I-Ba where M=Si, q=l, m=0, G=NH, R^{a}═R^{b}=hydrogen, R^{b}═R^{d}=methyl), 2,2-dimethyl-4-oxo-1,3,2-benzodioxasilin (compound of the formula I-Ba where M=Si, q=1, m=0, G=O, R^{a}+R^{b}═O, R^{c}═R^{d}=methyl) and 2,2-dimethyl-4-oxo-1,3,2-benzoxazasilin (compound of the formula IIIa where M=Si, q=1, m=0, G=NH, R^{a}+R^{b}═O, R^{c}═R^{d}=methyl). Such monomers are known, for example, from Wieber et al., Journal of Organometallic Chemistry; 1, 1963, 93, 94. Further examples of monomers I-Ba are 2,2-diphenyl[4H-1,3,2-benzodioxasilin] (J. Organomet. Chem. 1974, 71, 225); 2,2-di-n-butyl[4H-1,3,2-benzodioxastannin] (Bull. Soc. Chim. Belg. 1988, 97, 873); 2,2-dimethyl[4-methylidene-1,3,2-benzodioxasilin] (J. Organomet. Chem. 1983, 244, C₅-C₈); 2-methyl-2-vinyl[4-oxo-1,3,2-benzodioxazasilin].

In this embodiment, the molar ratio of monomer M1 to the at least one further monomer M2 is generally in the range from 5:95 to 95:5, preferably in the range from 10:90 to 90:10, particularly in the range from 15:85 to 85:15 and especially in the range from 20:80 to 80:20.

The homo- or copolymerization of the monomers of the formula I can be performed in bulk or in an inert diluent.

The preferred diluents include, in particular, aprotic organic solvents. These include, in particular, hydrocarbons which may be aliphatic, cycloaliphatic or aromatic, and mixtures thereof with halogenated hydrocarbons. Preferred solvents are hydrocarbons, for example acyclic hydrocarbons having generally 4 to 16 and preferably 3 to 8 carbon atoms, especially alkanes such as n-butane and isomers thereof, n-pentane and isomers thereof, n-hexane and isomers thereof, n-heptane and isomers thereof, and also n-octane, n-decane and isomers thereof, n-dodecane and isomers thereof, n-tetradecane and isomers thereof and n-hexadecane and isomers thereof, and additionally cycloalkanes having 5 to 16 carbon atoms, such as cyclopentane, methylcyclopentane, cyclohexane, methylcyclohexane, cycloheptane, cyclooctane, decalin, cyclododecane, biscyclohexylmethane, aromatic hydrocarbons such as benzene, toluene, xylenes, mesitylene, ethylbenzene, cumene (2-propylbenzene), isocumene (1-propylbenzene), tert-butylbenzene, isopropylnaphthalene or diisopropylnaphthalene, and also cycloaliphatic and aliphatic ethers such as tetrahydrofuran, diethyl ether, diisopropyl ether and tert-butyl methyl ether, and ethylene glycols such as diethylene glycol dimethyl ether, diethylene glycol diethyl ether and diethylene glycol dipropyl ether, and halogenated hydrocarbons such as halogenated aliphatic hydrocarbons, e.g. chloromethane, dichloromethane, trichloromethane, chloroethane, 1,2-dichloroethane and 1,1,1-trichloroethane and 1-chlorobutane, and halogenated aromatic hydrocarbons such as chlorobenzene, 1,2-dichlorobenzene and fluorobenzene. It is also possible to use mixtures of these diluents.

Preference is also given to mixtures of hydrocarbons with halogenated hydrocarbons. Preferably, the proportion of the hydrocarbons in the mixtures is at least 50% by volume, particularly at least 80% by volume and especially at least 90% by volume, based on the total amount of organic solvent.

In a preferred embodiment of the invention, the organic solvent used for polymerization comprises at least one aromatic hydrocarbon, especially at least one alkylaromatic, in particular mono-, di- or trialkylbenzenes and mono-, di- or trialkylnaphthalenes, e.g. toluene, xylene and xylene mixtures, 1,2,4-trimethylbenzene, mesitylene, ethylbenzene, cumene, isocumene, tert-butylbenzene, isopropylnaphthalene or diisopropylnaphthalene, and mixtures of these solvents. In this embodiment, the organic solvent comprises the aromatic hydrocarbon, especially alkylaromatics, preferably in an amount of at least 50% by volume, particularly at least 80% by volume and especially at least 90% by volume, based on the total amount of organic solvent. The remaining amount of organic solvents is selected in this embodiment preferably from alkanes and cycloalkanes.

When the reaction is performed in bulk, the concentration of monomer in the diluent is in the range from 1 to 500 g/l and especially in the range from 10 to 300 g/l.

Reaction in a solvent or diluent allows, in a simple manner, the production of particulate composite material with very small particle sizes. More particularly, the mean particle size of the particulate composite material thus produced (weight average of the primary particles, determined by laser light diffraction on diluted samples) is typically in the range from 1 nm to 10 μm and especially in the range from 10 nm to 3 μm.

In another embodiment of the invention, the homo- or copolymerization of the monomers of the formula I is conducted in bulk, i.e. in a melt of the monomers of the formula I, in which case the melt may optionally comprise up to 20% by weight and especially up to 10% by weight of an inert diluent.

Preference is given to performing the polymerization of the monomers of the formula I in the substantial absence of water, which means that the concentration of water at the start of the polymerization is less than 0.1% by weight. Accordingly, preferred monomers of the formula I are those monomers which do not release any water under polymerization conditions. These include especially the monomers of the formulae I-A, I-Aa, I-A′, I-Aa′, I-B and I-Ba.

The temperatures required for the process according to the invention are generally in the range from 50° C. to 200° C., especially in the range from 80° C. to 170° C.

The polymerization of the compounds of the formula I may be followed by purification steps and optionally drying steps. For example, the polymerization product obtained in the polymerization can be added to a suitable diluent in order to remove unreacted monomer and/or high-boiling solvent.

The polymerization of the compounds of the formula I may be followed by a calcination. This involves carbonizing the organic polymeric material formed in the polymerization of the monomer unit(s) B to give the carbon phase. For further details, reference is made here to the prior art cited at the outset regarding the polymerization of monomers of the formula I.

The polymerization of the compounds of the formula I may be followed by an oxidative removal of the organic polymer phase. This involves oxidizing the organic polymeric material formed in the polymerization of the organic constituents to obtain a nanoporous oxidic, sulfidic or nitridic material. For further details, reference is made here to the prior art cited at the outset regarding the polymerization of monomers of the formula I.

As already explained above, a particular configuration of the process according to the invention relates to the production of a coating. For this purpose, a thin layer of the monomers of the formula I will be polymerized. This monomer layer is typically applied to the surface to be coated prior to the polymerization.

The monomers of the formula I can be applied in a manner known per se. In general, the monomers of the formula I will be applied to the surface to be coated in liquid form, for example in the form of a melt or in the form of a solution in a suitable diluent.

When the monomers of the formula I are applied to the surface to be coated in the form of a solution, the diluent will preferably be removed prior to the polymerization. The diluent is therefore preferably a volatile organic solvent whose boiling point at standard pressure preferably does not exceed 120° C. and is especially in the range from 40 to 120° C. Examples of suitable organic solvents for this purpose are aromatic hydrocarbons such as toluene and xylenes, ethers such as tetrahydrofuran, diethyl ether, diisopropyl ether or tert-butyl methyl ether, and alkanes such as n-hexane or cyclohexane.

The monomers of the formula I will preferably be applied to the surface to be coated in an amount of 0.1 to 5000 g/m², particularly in an amount of 1 to 1000 g/m² and especially 5 to 500 g/m². In this way, coatings are obtained in a thickness of 0.1 to 5000 μm, particularly in the range of 1 to 1000 μm, especially 5 to 500 μm.

The substrates to be coated are suitably stable with respect to bases. Examples of suitable substrates are metals, glass, ceramic, and polymeric materials.

As already mentioned, a preferred configuration of the process according to the invention relates to the production of a coating, which comprises the following steps:
i) applying a layer of at least one monomer of the formula I as defined in claim 1 to a surface to be coated in presence of a basic catalyst and
ii) triggering a homo- or copolymerization of the at least one monomer of the formula I in the layer by heating the layer.

To produce the coating, the temperature in step i) will generally be kept here at −30° C. to 50° C., preferably 0° C. to 30° C., more preferably 15° C. to 25° C. The temperature in step ii) will generally be kept within the range from 50° C. to 200° C., especially within the range from 80° C. to 150° C.

In the composite materials obtained by the process according to the invention, the inorganic or organometallic phase comprises the metal or semimetal M and optionally, when X or Y is a chemical bond, the organic R^{1′} and R^{2′} radicals. The at least one organic polymer phase in turn comprises polymers with aromatic or heteroaromatic structural units which from the polymerization of the R¹ and R² radicals and optionally, when X and Y are not a chemical bond, of the R^{1′} and R^{2′} radicals.

As already explained above, the dimensions of the phase domains in the composite materials obtained in accordance with the invention are generally less than 200 nm and are frequently in the region of a few nanometers, for example not more than 50 nm or not more than 20 nm or not more than 10 nm or not more than 5 nm. However, it is possible to obtain materials with domain sizes up to 100-200 nm. In addition, the phase domains of the inorganic or organometallic phase and the phase domains of the organic phase in the composite materials obtained in accordance with the invention generally have a co-continuous arrangement, i.e. both the organic phase and the inorganic or organometallic phase penetrate one another and essentially do not form any discontinuous regions. The distances between adjacent phase boundaries, or the distances between the domains of adjacent identical phases, are extremely small here and are generally on average not more than 200 nm, frequently on average not more than 50 nm or 20 nm and especially on average not more than 10 nm or not more than 5 nm. However, it is possible to obtain materials with domain sizes up to 100-200 nm. There is typically no occurrence of macroscopically visible separation into discontinuous domains of the particular phase in the process according to the invention.

The mean distance between the domains of adjacent identical phases can be determined by means of combined small-angle X-ray scattering (SAXS) via the scatter vector q (measurement in transmission at 20° C., monochromatized CuK_{α} radiation, 2D detector (image plate), slit collimation).

With regard to the terms “continuous phase domain”, “discontinuous phase domain” and “co-continuous phase domain”, reference is also made to W. J. Work et al., Definitions of Terms Related to Polymer Blends, Composites and Multiphase Polymeric Materials, (IUPAC Recommendations 2004), Pure Appl. Chem. 2004, 76, 1985-2007, especially page 2003. According to this, a co-continuous arrangement of a two-component mixture is understood to mean a phase-separated arrangement of the two phases, in which within one domain of the particular phase a continuous path through either phase domain may be drawn to all phase boundaries without crossing any phase domain boundary.

The composite materials obtainable in accordance with the invention can be converted in a manner known per se to nanoporous inorganic materials, by oxidatively removing the organic constituents of the composite material obtained in accordance with the invention. This preserves the nanostructure of the inorganic or organo(semi)metallic phase present in the composite material obtained in accordance with the invention, and the result, depending on the monomers of the formula I selected, is an oxide or nitride of the (semi)metal or a mixed form. The oxidation is effected typically by heating in an oxygenous atmosphere as described in the article by Spange et al. cited at the outset. In general, heating is effected with ingress of oxygen at a temperature in the range from 400 to 1500° C., especially in the range from 500 to 1000° C. The heating is typically effected in an oxygenous atmosphere, for example in air or other oxygen/nitrogen mixtures, the proportion by volume of oxygen being variable over wide ranges and being, for example, in the range from 5 to 50% by volume.

The composite materials obtainable in accordance with the invention can also be converted to an electrically active composite material which, as well as an inorganic phase of a (semi)metal, which may be either oxidic or (semi)metallic, has a carbon phase C. Such materials are obtainable by calcining the composite material obtainable in accordance with the invention with substantial or complete exclusion of oxygen. In the carbonaceous nanocomposite material, a carbon phase C and the inorganic phase essentially form the above-described phase arrangement. In general, the calcination is performed at a temperature in the range from 400 to 2000° C., especially in the range from 500 to 1000° C. The calcination is then typically effected with substantial exclusion of oxygen. In other words, during the calcination, the partial oxygen pressure in the reaction zone in which the calcination is performed is low, and will preferably not exceed 20 mbar, especially 10 mbar. Preference is given to performing the calcination in an inert gas atmosphere, for example under nitrogen or argon. The inert gas atmosphere will preferably comprise less than 1% by volume, especially less than 0.1% by volume, of oxygen. In a likewise preferred embodiment of the invention, the calcination is performed under reducing conditions, for example in an atmosphere which comprises hydrogen (H₂), hydrocarbon gases such as methane, ethane or propane, or ammonia (NH₃), optionally as a mixture with an inert such as nitrogen or argon. To remove volatile constituents, the calcination can be performed in an inert gas stream or in a gas stream which comprises reducing gases such as hydrogen, hydrocarbon gases or ammonia.

The examples and figures which follow serve to illustrate the invention.

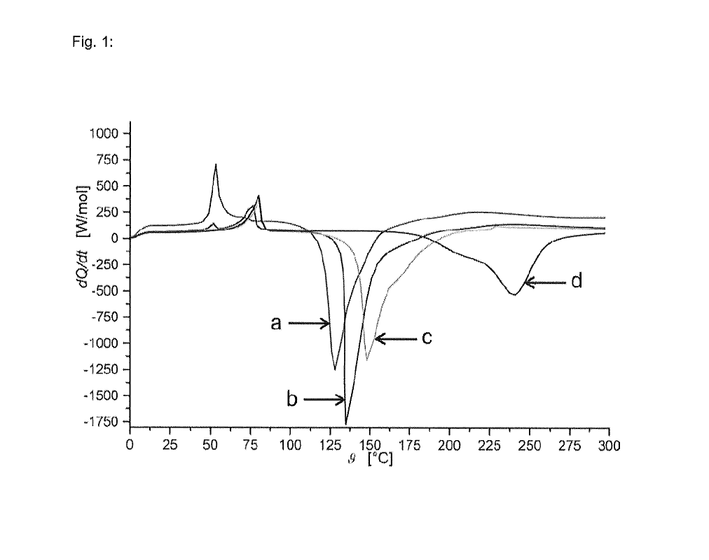

FIG. 1 shows DSC analyses of monomer A with 1,8-bis(dimethylamino)naphthalene (BDMAN) as a base in various molar ratios of monomer A to 1,8-bis(dimethylamino)-naphthalene (BDMAN) at a heating rate of 10 K/min under a nitrogen atmosphere. The molar ratios of monomer A to BDMAN in the DSC analysis curves a, b, c and d shown are as follows:

curve a: 0.9:1.0
curve b: 8.8:1.0
curve c: 20.7:1.0
curve d: comparative analysis without addition of BDMAN

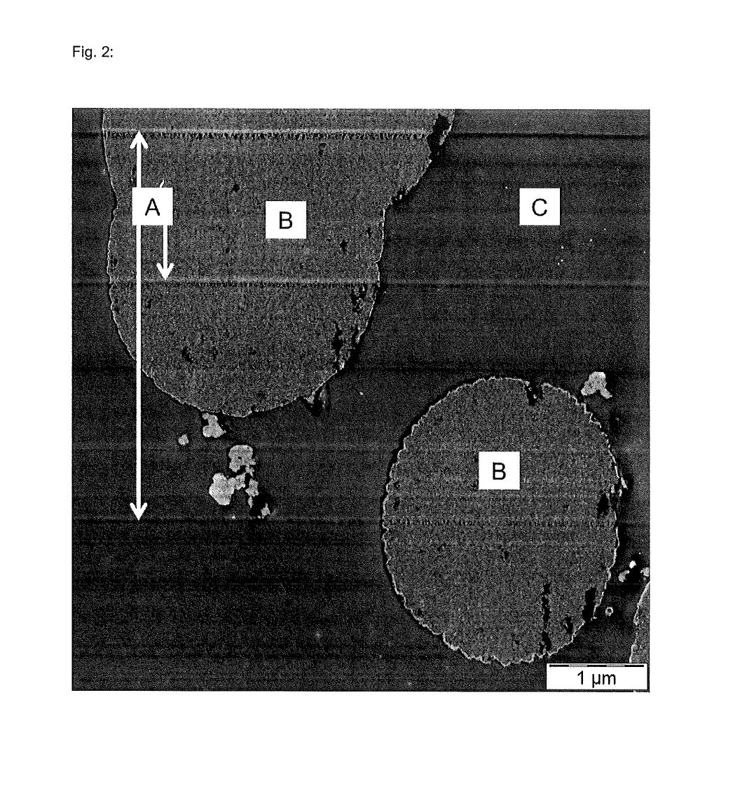

FIG. 2 shows an HAADF-STEM image of polymerization example 1 (scale 20 000:1). The labels in the figure have the following meanings:

A: preparation artefacts
B: composite particle
C: embedding composition

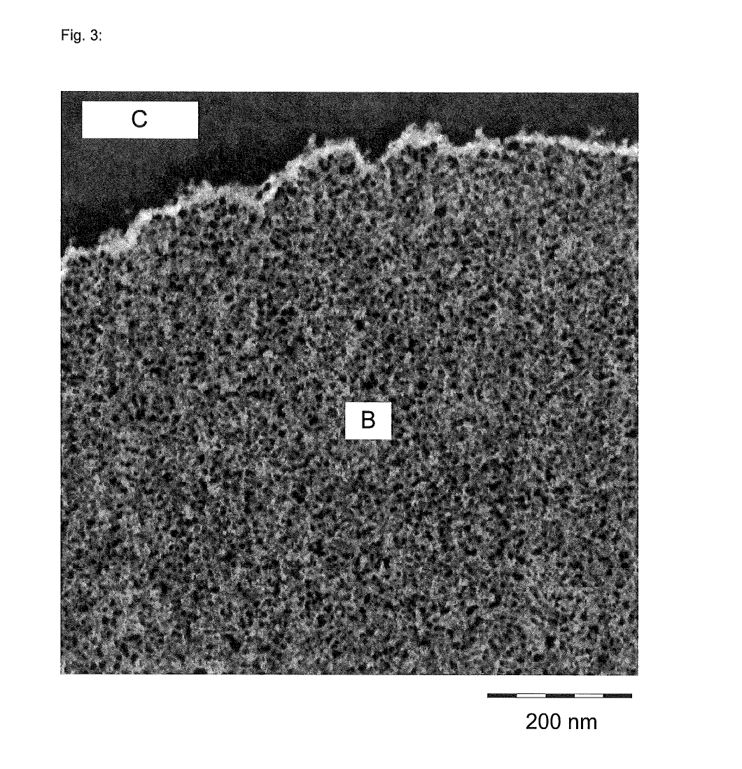

FIG. 3 shows an HAADF-STEM image of polymerization example 1 (scale 200 000:1). The labels in the figure have the same meanings as in FIG. 2. In the composite particles, light and dark regions are observed, the light regions being silicon-rich and the dark regions polymer-rich.

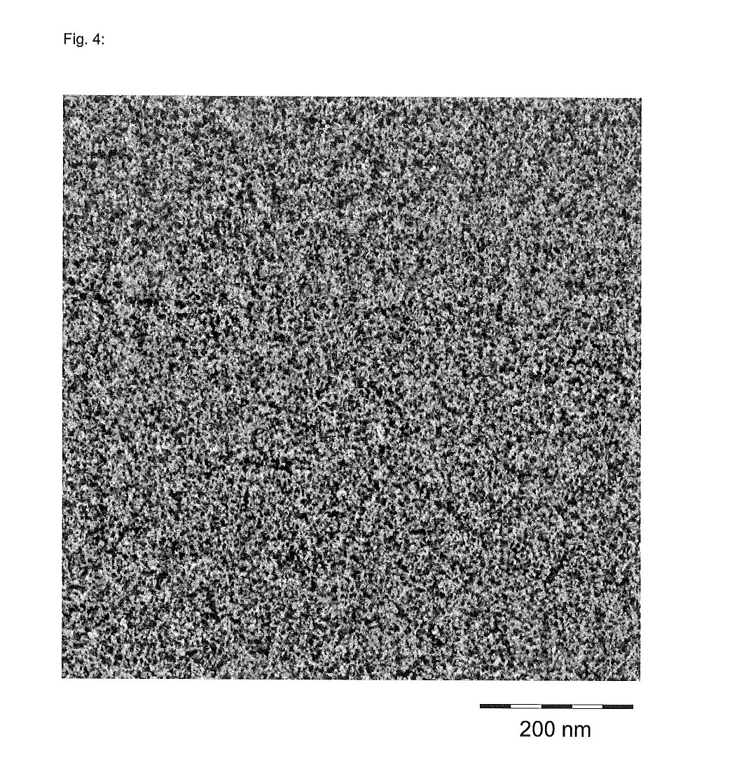

FIG. 4 shows an HAADF-STEM image of polymerization example 2 (scale 200 000:1). A section from a composite particle is shown. Light and dark regions are observed, the light regions being silicon-rich and the dark regions polymer-rich.

### EXAMPLES

### I) Transmission Electron Microscopy Analyses (TEM)

The samples obtained in the polymerization were analyzed by means of TEM: the TEM analyses were performed as HAADF-STEM with a Tecnai F20 transmission electron microscope (FEI, Eindhoven, the Netherlands) at a working voltage of 200 kV using ultrathin layer methodology (embedding of the samples into synthetic resin as a matrix).

### II) Monomers

The following monomers were used:

Monomer A: 2,2′-spirobis[4H-1,3,2-benzodioxasilin]: preparation example 1;
Monomer B: 2,2-dimethyl[4H-1,3,2-benzodioxasilin]: Tetrahedron Lett. 1983, 24, 1273.

### III) Bases

The following bases were used:

1,8-bis(dimethylamino)naphthalene (BDMAN), tetra-n-butylammonium fluoride (TBAF), 1,8-diazabicyclo[5.4.0]undec-7-ene (DBU), pyrrolidine, pyridine, 4-(dimethylamino)-pyridine (DMAP), piperidine and 1,1,3,3-tetramethylguanidine.

### IV) DSC Analyses

All DSC analyses were conducted with a Mettler DSC₃₀, STARE SW 9.01 software, under a nitrogen atmosphere. Using a microbalance under a nitrogen atmosphere, the monomer was weighed into an aluminum crucible. The base was optionally added under a nitrogen atmosphere and the crucible was closed. Then the DSC analysis was started. The heating rate in all analyses was 10 K/min.

The polymerization of the monomers A with addition of BDMAN in various concentration ratios was analyzed by means of DSC. The analysis results are shown in FIG. 1 (see also description of figures). The results show that the addition of BDMAN to monomer A in molar ratios of monomer A to BDMAN of 20.7:1 to 0.9:1 brings about polymerization of the monomers A at significantly lower temperature compared to the analysis without addition of BDMAN.

The polymerization of the monomers A with addition of pyrrolidine, pyridine, tetra-n-butylammonium fluoride (TBAF), 1,8-diazabicyclo[5.4.0]undec-7-ene (DBU), pyrrolidine, pyridine, 4-(dimethylamino)pyridine (DMAP), piperidine or 1,1,3,3-tetramethylguanidine was analyzed by means of DSC and the respective peak maximum of the polymerization reaction was determined. The results are listed in the following comparison:

| | Molar ratio of | Peak maximum |
|---|---|---|
| Base | monomer A:base | in ° C. |
| Pyrrolidine | 1.8:1.0 | 124 |
| Pyridine | 4.2:1.0 | 125 |
| Tetra-n-butylammonium fluoride | 8.1:1.0 | 132 |
| 1,8-Diazabicyclo[5.4.0]undec-7-ene | 9.2:1.0 | 133 |
| 4-(Dimethyiamino)pyridine | 34.2:1.0 | 158 |
| Piperidine | 6.5:1.0 | 175 |
| 1,1,3,3-Tetramethylguanidine | 6.7:1.0 | 120 |

The results show that all bases listed bring about polymerization of the monomers A at significantly lower temperature (peak maxima in the range from 120° C. to 175° C.) than without addition of base. In the case of polymerization of the monomers A without addition of base, the peak maximum is more than 235° C. (see FIG. 1).

### V) Preparation Examples

### Preparation Example 1

### 2,2′-spirobis[4H-1,3,2-benzodioxasilin] (monomer A)

135.77 g of salicyl alcohol (1.0937 mol) were dissolved in toluene at 85° C. Subsequently, 83.24 g (0.5469 mol) of tetramethoxysilane (TMOS) were slowly added dropwise, in the course of which, after addition of one third of the TMOS, 0.3 ml of tetra-n-butylammonium fluoride (1 M in tetrahydrofuran) was injected all at once. The mixture was stirred at 85° C. for 1 h and then the methanol/toluene azeotrope was distilled off (63.7° C.). The remaining toluene was removed on a rotary evaporator. The product was removed by dissolution from the resulting reaction mixture with hexane at 70° C. After cooling to 20° C., the clear solution was decanted off. After removing the hexane, the title compound remained as a white solid. The product can be purified further to remove impurities by reprecipitation with hexane.

¹H NMR (400 MHz, CDCl₃, 25° C., TMS) δ [ppm]=5.21 (m, 4H, CH₂), 6.97-7.05 (m, 6H), 7.21-7.27 (M, 2H).

¹³C NMR (100 MHz, CDCl₃, 25° C.): δ [ppm]=66.3 (CH₂), 119.3, 122.3, 125.2, 125.7, 129.1, 152.4.

²⁹Si CP-MAS (79.5 MHz): δ [ppm]=−78.4

### VI) Polymerization Examples

### Polymerization Example 1

Under a gentle argon flow, 6.58 g (0.024 mol) of monomer A were dissolved in 90 ml of p-xylene and heated to 138° C. under reflux cooling. 0.805 ml of a solution of tetra-n-butylammonium fluoride (1 M in tetrahydrofuran) was injected all at once. The mixture was stirred at 138° C. for 2 h and left to cool to 20° C. The solids were filtered off and washed with p-xylene, chloroform, acetone and distilled water. After drying, a fine, colorless solid was obtained. The HAADF-STEM analysis showed composite particles in a size of approximately 1 to 3 μm (FIGS. 2 and 3).

### Polymerization Example 2

A PTFE reaction vessel was initially charged with 4.065 g of monomer A and 2.690 g of monomer B. The reaction mixture was heated to 85° C. while stirring, until a clear melt formed. 0.045 g of 1,8-diazabicyclo[5.4.0]undec-7-ene (DBU) was added all at once. The reaction mixture was heated to 110° C. for 8 h. The reaction mixture solidified and was elastic. The reaction mixture was heated to 110° C. for a further 3 h. The composite material was obtained in the desired composition. The sample obtained was homogeneous. The HAADF-STEM analysis (FIG. 4) showed a finer structure of the composite particles compared to polymerization example 1 (FIG. 3).

### Polymerization Example 3

A PTFE reaction vessel was initially charged with 3.813 g of monomer A and 2.544 g of monomer B. The reaction mixture was heated to 85° C. while stirring, until a clear melt formed. 0.120 g of 1,8-bis(dimethylamino)naphthalene (BDMAN) was added all at once. The reaction mixture was heated to 110° C. for 15 h and to 160° C. for 3 h. The composite material was obtained in the desired composition. The sample obtained was homogeneous.

1-15. (canceled)

16. A process for producing a composite material composed of
a) at least one inorganic or organometallic phase; and
b) an organic polymer phase with aromatic or heteroaromatic structural units;
said process comprising the homo- or copolymerization of at least one monomer of the formula I 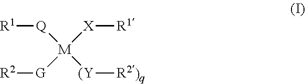
wherein
M is a metal or semimetal;
R¹, R² are, identically or differently on each occurrence, an Ar—C(R^{a},R^{b})— radical wherein Ar is an aromatic or heteroaromatic ring optionally comprising 1 or 2 substituents selected from halogen, CN, C₁-C₆-alkoxy, and phenyl, and R^{a}, R^{b} are each independently hydrogen or methyl or together are an oxygen atom or a methylidene group (═CH₂),
or the R¹Q and R²G radicals together are a radical of the formula A 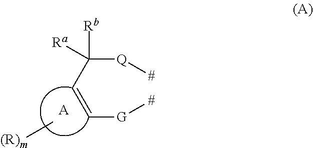
wherein A is an aromatic or heteroaromatic ring fused to the double bond, m is 0, 1 or 2, the R radicals are, identically or differently on each occurrence, selected from halogen, CN, C₁-C₆-alkyl, C₁-C₆-alkoxy, and phenyl, and R^{a}, R^{b} are each as defined above;
G is O, S, or NH;
Q is o, S, or NH;
q according to the valency and charge of M is 0, 1, or 2;
X, Y are, identically or differently on each occurrence, O, S, NH, or a chemical bond;
R^{1′},R^{2′} are, identically or differently on each occurrence, C₁-C₆-alkyl, C₃-C₆-cycloalkyl, aryl, or an Ar′-C(R^{a′},R^{b′})-radical wherein Ar′ is as defined for Ar and R^{a′}, R^{b′} are each as defined for R^{a}, R^{b}, or R¹, R^{2′} together with X and Y are a radical of the formula A, as defined above,
or, when X is oxygen, the R^{1′} radical may be a radical of the formula: 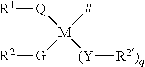
wherein q, R¹, R², R^{2′}, Y, Q and G are each as defined above and # is the bond to X;
wherein the polymerization is performed in the presence of a base selected from organic nitrogen bases and inorganic or organic oxo bases and fluoride salts.

17. The process of claim 16, wherein the conjugate acid of the organic nitrogen base has a pKₐ of 4.0 or more, measured in water at 25° C.

18. The process of claim 16, wherein the base is selected from secondary and tertiary organic amines, alkali metal hydroxides, alkaline earth metal hydroxides, C₁-C₁₀-alkoxides, and quaternary ammonium fluorides.

19. The process of claim 16, wherein the organic nitrogen base is selected from tertiary amidine bases and 1,8-bis(di-C₁-C₄-alkylamino)naphthalinenes.

20. The process of claim 16, wherein the organic nitrogen base is selected from 1,8-bis(dimethylamino)naphthalene, pyrrolidine, 1,1,3,3-tetramethylguanidine, 1,8-diazabicyclo[5.4.0]undec-7-ene, 1,5-diazabicyclo[4.3.0]non-5-ene, 4-(dimethylamino)pyridine, pyridine, and piperidine.

21. The process of claim 16, wherein the organic nitrogen base is selected from 1,8-bis(dimethylamino)naphthalene, 1,8-diazabicyclo[5.4.0]undec-7-ene and 1,5-diazabicyclo[4.3.0]non-5-ene.

22. The process of claim 16, wherein the base is used in an amount of 0.01 mmol to 2 mmol, based on 4 mmol of the monomers of the formula I.

23. The process of claim 16, wherein the metal or semimetal M in formula I is selected from B, Al, Si, Ti, Zr, Hf, Ge, Sn, Pb, V, As, Sb, and Bi.

24. The process of claim 16, wherein G and Q in formula I are each oxygen.

25. The process of claim 16, wherein the monomers of the formula Ito be polymerized have at least one monomer unit A.

26. The process of claim 25, wherein the monomers of the formula Ito be polymerized comprise at least one monomer of the general formula I-A: 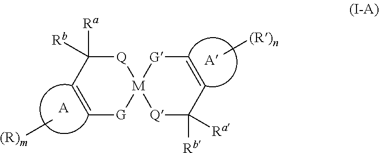
wherein
M is a metal or semimetal;
A and A′ are each an aromatic or heteroaromatic ring fused to the double bond;
m and n are each independently 0, 1, or 2;
G and G′ are, identically or differently on each occurrence, independently O, S, or NH;
Q and Q′ are, identically or differently on each occurrence, independently O, S, or NH;
R and R′ are, identically or differently on each occurrence, independently selected from halogen, CN, C₁-C₆-alkyl, C₁-C₆-alkoxy, and phenyl; and
R^{a}, R^{b}, R^{a′}, R^{b′} are each independently selected from hydrogen and methyl, or R^{a} and R^{b} and/or R^{a′} and R^{b′} in each case together are an oxygen atom or a methylidene group.

27. The process of claim 26, wherein the monomers to be polymerized comprise at least one first monomer M1 of the formula I-A and at least one second monomer M2 selected from the monomers of the formula I-B: 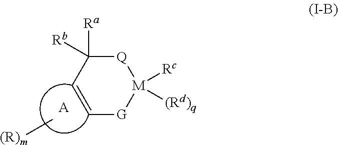
wherein
M is a metal or semimetal;
A is an aromatic or heteroaromatic ring fused to the double bond;
m is 0, 1, or 2;
q according to the valency and charge of M is 0, 1, or 2;
G is O, S, or NH;
Q is o, S, or NH;
R is independently selected from halogen, CN, C₁-C₆-alkyl, C₁-C₆-alkoxy, and phenyl;
R^{a}, R^{b} are each independently selected from hydrogen and methyl, or R^{a} and R^{b} together are an oxygen atom or a methylidene group, and
R^{c}, R^{d} are, identically or differently on each occurrence, selected from C₁-C₆-alkyl, C₃-C₆-cycloalkyl, and aryl.

28. The process of claim 26, wherein, in formula I-A:
M is silicon;
A and A′ are each a benzene ring fused to the double bond;
m and n are each independently 0 or 1;
G, G′, Q, and Q′ are each O;
R and R′ are the same or different and are each independently selected from halogen, CN, C₁-C₆-alkyl, and C₁-C₆-alkoxy; and
R^{a}, R^{b}, R^{a′}, R^{b} are each hydrogen.

29. The process of claim 16, wherein the polymerization of the monomers of the formula I is performed in a solution of the monomer of the formula I in an aprotic organic solvent or solvent mixture.

30. The process of claim 16, wherein the polymerization of the monomers of the formula I is performed in bulk.

31. The process of claim 27, wherein M is Si.
